(19) United States
(12) Patent Application Publication
(10) Pub. No.: US 2025/0304420 A1
(43) Pub. Date: Oct. 2, 2025

(54) APPARATUS FOR CLOSING CONTAINERS AND ASSOCIATED OPERATING METHOD

(71) Applicant: KRONES AG, Neutraubling (DE)

(72) Inventors: Martin KAUFMANN, Hemau (DE); Florian FUCHS, Mehring (DE)

(21) Appl. No.: 19/092,585

(22) Filed: Mar. 27, 2025

(30) Foreign Application Priority Data
Mar. 27, 2024 (DE) 10 2024 108 789.7

(51) Int. Cl. B67B 3/26; B67B 3/10; B67C 7/00

(52) U.S. Cl. CPC B67B 3/264; B67B 3/10; B67C 7/00

(57) ABSTRACT

The invention relates to, among other things, a method for operating an apparatus for closing containers. An electric drive device of the apparatus is operated in order to move a closing element of the apparatus to a container received in a container receptacle of the apparatus in order to apply a closure to the container. A following error of the electric drive device during operation of the electric drive device for moving the closing element to the container is monitored via a processing device of the apparatus. If the monitored following error reaches or exceeds a prespecified limit value, the electric drive device is operated to abort the movement of the closing element to the container and to move the closing element away from the container.

### CROSS-REFERENCE TO RELATED APPLICATIONS

This application claims the benefit under 35 U.S.C. § 119(a) of German Patent Application No. DE 10 2024 108 789.7, filed Mar. 27, 2024, entitled APPARATUS FOR CLOSING CONTAINERS AND ASSOCIATED OPERATING METHOD, and whose entire disclosure is incorporated by reference herein.

### TECHNICAL FIELD

The invention relates to a method for operating an apparatus for closing containers. The invention further relates to an apparatus for closing containers.

### TECHNICAL BACKGROUND

Apparatuses for applying closures to containers filled with a filling material are known. Depending on the type of closure, more or less force may occur when a container is being closed. If, during closing, the container mouth and a closing element of the apparatus that applies the closure are not immediately positioned within a narrow tolerance range in relation to one another, the container may for example be damaged. For example, glass bottles can break. Container fragments and the escaping filling material can contaminate and even damage the closing apparatus, in particular its seals. The drives of the closing apparatus can also be damaged by excessive forces acting during closing. A malfunction can cause the entire apparatus to stop automatically and to have to be restarted manually. Further unwanted downtimes occur due to necessary cleaning work and, if necessary, repair work.

Incorrect positioning between the closing element and the container mouth can occur, for example if the container is positioned too high due to incorrect locking of a lifting cylinder supporting the container or due to a double fitting of the closing element with closures.

The closing elements for applying the closures can be driven and moved in different ways. For example, DE 10 2012 209 905 A1, DE 10 2012 219 760 A1 and DE 10 2012 219 757 A1 disclose, in each case, a closing head driven by an electric motor.

The invention is based on the object of developing an improved technology for preventing damage to containers and to the closing apparatus, as well as for preventing contamination of the closing apparatus, without the technology impairing the operation of the closing apparatus.

### SUMMARY OF THE INVENTION

The object is achieved by the features of the independent claims. Advantageous developments are specified in the dependent claims and the description.

An aspect of the present disclosure relates to a method for operating an apparatus for closing containers. The method comprises operating an electric (for example, linear) drive device, preferably a servo drive unit, of the apparatus in order to move a closing element of the apparatus to a container received (for example, held and/or supported and/or gripped/clamped at the base) in a container receptacle of the apparatus in order to apply a closure to the container (for example, by means of a processing device of the apparatus). The method further comprises monitoring a following error (for example, a load-related position deviation) of the electric drive device during operation of the electric drive device in order to move the closing element to the container by means of a processing device of the apparatus. The method further comprises operating the electric drive device in order to abort the movement of the closing element to the container and to move the closing element away from the container when the monitored following error reaches or exceeds a specified limit value (for example, doing so by means of the processing device of the apparatus).

Advantageously, the method makes it possible to detect when the closing element and the container mouth come into contact too early outside a tolerance range, for example due to the container being positioned too high or due to a double fitting of the closing element. The contact can lead to an increase in the following error and can therefore be detected at an early stage. If the limit value for the following error is selected sufficiently small, the movement of the closing element can be aborted before damage to the container and possible overloading of the drive device, etc., occurs. The subsequent movement away can enable the apparatus to continue to operate safely. There will be no contamination, damage, or unwanted downtime of the apparatus. The container, not sealed but undamaged, can then be easily removed later.

In one exemplary embodiment, the movement of the closing element to the container is in a vertical direction downwards. Alternatively or additionally, the closing element can be moved away from the container in a vertical direction upwards. Alternatively or additionally, during the away movement the closing element can be moved away to a prespecified target position, which preferably corresponds to a starting position of the movement to the container. Alternatively or additionally, during the away movement the closing element can move back along a movement path previously followed when moving to the container. This can advantageously make a safe and defined movement of the closing element possible.

In a further exemplary embodiment, monitoring the following error of the electric drive device is or includes monitoring a deviation between a target position, preferably a target height position (for example, of the closing element, of a capper drive axis, or of a drive axis of the electric drive device) and an actual position, preferably an actual height position (for example, of the closing element, of a capper drive axis, or of a drive axis of the electric drive device). Preferably, the prespecified limit value can be a prespecified maximum deviation between the target position and the actual position. Alternatively or additionally, the specified limit value can be, for example, ≤2 mm or ≤1.5 mm or ≤1 mm. Advantageously, the following error can be monitored particularly reliably in this way and critical situations can be detected at an early stage.

In one embodiment, the monitoring of the following error takes place at the electric drive device, preferably at a drive axis of the electric drive device, or at a capper drive axis which connects the electric drive device to the closing element. Advantageously, the following error can be monitored particularly reliably in this way.

In a further embodiment, the movement comprises a (for example, translational) movement of the closing element (for example, in a vertical direction downwards) to an application position for starting an application of the closure to a container mouth of the container and/or a (for example, translational and/or rotational) movement (for example, in a vertical direction downwards) of the closing element from an application position to a closing position in order to apply the closure to the container mouth. The following error can be monitored, for example, during operation of the electric drive device for moving the closing element to the application position. Alternatively or additionally, the following error can be monitored, for example, during operation of the electric drive device for moving the closing element from the application position to the closing position. In this way, different scenarios of incorrect positioning between the closing element and the container mouth can be advantageously detected.

In one embodiment variant, if the monitored following error reaches or exceeds the prespecified limit, a warning is issued at a user interface. Alternatively or additionally, the container assigned to the closing element can be subsequently ejected during monitoring of the following error. Alternatively or additionally, operation of the apparatus for closing subsequent containers can be continued without interruption. This advantageously makes it possible for the apparatus to continue operating without any downtime.

In a further embodiment variant, the processing device is part of a servo converter connected to the electric drive device, preferably with a cycle time in the three-digit μs range, particularly preferably ≤500 μs or ≤400 μs. This advantageously makes a particularly fast-reacting and high-resolution monitoring of the following error possible and thus a particularly early detection of critical situations, as a result of which damage to the container and the apparatus can be reliably prevented.

In one exemplary embodiment, the operation of the electric drive device for moving the closing element to the container in order to apply the closure to the container is carried out by means of the processing device and a further processing device. Optionally, the operation of the electric drive device for aborting the movement of the closing element to the container and for moving the closing element away from the container is carried out by means of the processing device, which overrides the further processing device. As already explained, this advantageously makes a particularly fast-reacting and high-resolution monitoring of the following error possible.

In a further exemplary embodiment, the further processing device is a processing device that is a higher-order processing device than the processing device and/or the further processing device has a longer cycle time than the processing device and/or the further processing device is a central processing device of the apparatus. In this way, the advantages of high-resolution monitoring and the thereby enabled rapid response to critical situations can advantageously be realized particularly effectively.

In one embodiment, the method further comprises prespecifying, by means of a user interface of the apparatus, at least one parameter, preferably a target position, a speed, an acceleration and/or a deceleration, of the closing element, specifically for the away movement. Preferably, the operation of the electric drive device for moving the closing element away from the container can be carried out according to the at least one prespecified parameter. In this way, the user can advantageously prespecify parameters specifically for the away movement, whereby the away movement can resolve the critical situation particularly reliably and safely.

In a further embodiment, the apparatus is a pure closing apparatus. Alternatively, the apparatus can be, for example, an integrated filling and closing apparatus, preferably with a treatment chamber in which at least one container mouth of the container can be accommodated, preferably in a sealed manner, for the filling and closing of the container. Optionally, the monitoring of the following error can take place during, preferably only during, the movement of the closing element within the treatment chamber.

It is possible that, for example, the monitoring of the following error is deactivated during a CIP cleaning operation of the filling and closing apparatus.

Another aspect of the present disclosure relates to an apparatus for closing containers, preferably a rotary closing apparatus. The apparatus comprises (at least) one container receptacle for receiving (for example, holding and/or supporting and/or gripping/clamping at the base) a container. The apparatus comprises (at least) one closing element which is movable, preferably in a vertical direction downwards, for movement to a container received in the container receptacle (for example, held and/or supported and/or gripped/clamped at the base) for the application of a closure to the container. The apparatus comprises (at least) one electric drive device, preferably a servo drive unit, wherein the electric drive device is connected (for example, via a drive axis) to the closing element in order to drive the closing element to move to the container. The apparatus comprises a processing device configured to carry out a method as disclosed herein for operating the apparatus. Advantageously, the apparatus can be used to secure the same advantages already explained with reference to the method. The same applies to the preferred exemplary embodiments of the apparatus explained below.

In one exemplary embodiment, the processing device is part of a servo converter connected to the electric drive device, preferably with a cycle time in the three-digit μs range, particularly preferably ≤500 μs or ≤400 μs. Alternatively or additionally, the apparatus can for example comprise a further processing device which, together with the processing device, is configured to operate the electric drive device in order to move the closing element to the container in order to apply the closure to the container. Preferably, the processing device can be configured to override the further processing device when the processing device operates the electric drive device to abort the movement of the closing element to the container and to move the closing element away from the container. Alternatively or additionally, the further processing device can preferably be a processing device that is superordinate to the processing device and/or can have a longer cycle time than the processing device and/or can be a central processing device of the apparatus.

In a further exemplary embodiment, the device further comprises a user interface configured to receive, through a user input, at least one parameter, preferably a target position, a speed, an acceleration and/or a deceleration, of the closing element specifically for the away movement. Preferably, the processing device can be further configured to operate the electric drive device according to the at least one prespecified parameter in order to move the closing element away from the container.

In a further exemplary embodiment, the apparatus is a pure closing apparatus. Alternatively, the apparatus can be, for example, an integrated filling and closing apparatus, preferably with a treatment chamber in which at least one container mouth of the container can be accommodated, preferably in a sealed manner, for the filling and closing of the container. Optionally, the monitoring of the following error can take place during, preferably only during, the movement of the closing element within the treatment chamber.

A further aspect of the present disclosure relates to a container processing facility (for example for controlling the temperature, producing, cleaning, coating, testing, filling, closing, pasteurizing, labeling, printing, marking, laser marking and/or packaging containers for liquid or pasty media, preferably beverages, liquid foods or products from the pharmaceutical or health care industry). The container processing facility can comprise the apparatus as disclosed herein.

For example, the containers can be realized as bottles, cans, canisters, cartons, vials, tubes, etc.

Preferably, the term “processing device” can refer to an electronic system (for example, designed as a driver circuit or with microprocessor(s) and data memory) which, depending on the design, can perform control tasks and/or regulation tasks and/or processing tasks. Although the term “control” is used herein, this can also comprise or be understood as “closed-loop control” or “control with feedback” and/or “processing” as appropriate.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 is a schematic representation of an apparatus for closing containers in accordance with an exemplary embodiment of the present disclosure;

FIG. 2 shows two schematic representations for explaining an operation of the exemplary apparatus; and

FIG. 3 shows a plurality of representations for explaining a monitoring of a following error of a drive device of the exemplary device for closing containers.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EXEMPLARY EMBODIMENTS

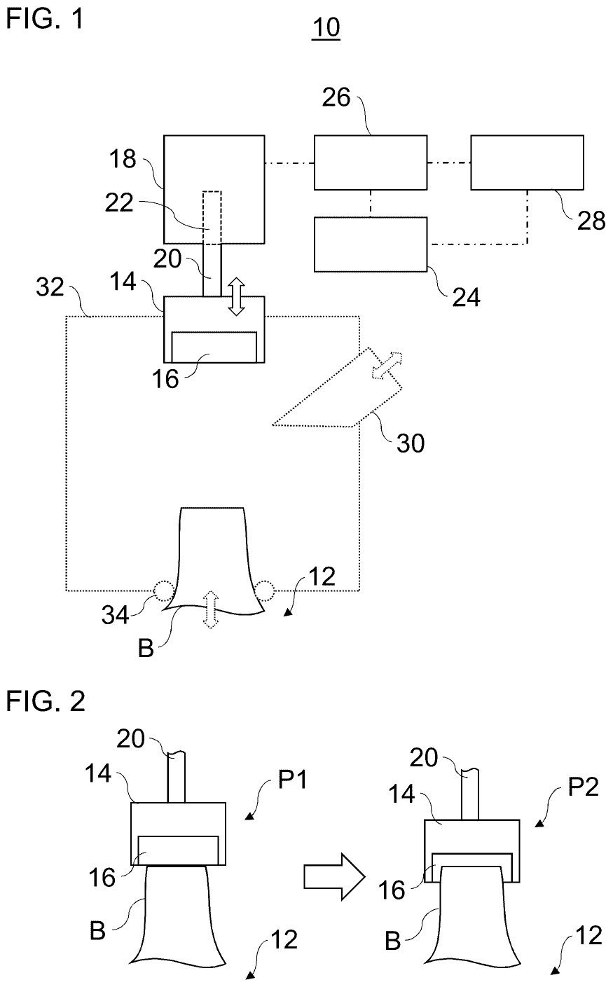

FIG. 1 shows an apparatus 10 for closing containers B.

The apparatus 10 comprises a container receptacle 12, a closing element 14, an electric drive device 18, and a processing device 26. Preferably, the apparatus 10 can further comprise a further processing device 28 and/or a user interface 24.

The container B is received (positioned) in the container receptacle 12 (not shown in detail in FIG. 1) during closing. For example, the container receptacle may have a container holder for holding the container B. The container holder can, for example, be a container plate (a support plate) for supporting the container B at the base. The container B can stand on the container plate. Alternatively or additionally, the container holder can support the container B, for example, on its container body or container neck ring, for example as a container clamp.

The closing element 14 is movable in order to be moved to a container B received in the container receptacle 12 and for application of a closure 16 to the container B. Preferably, the closing element 14 is movable downwards and upwards in a vertical direction. In detail, the closing element 14 can be moved to a container mouth of a container B received in the container receptacle 12 and can then apply the closure 16 to the container mouth. It is possible for the closure 16 to be for example pressed, pushed or screwed onto the container B by means of the closing element 14.

The closure 16 that can be applied by the closing element 14 can be, for example, a lid, a cork, a crown cap or a screw cap. Particularly preferably, the closing element 14 is designed to close the container B with a closure 16 taking the form of a crown cap. The closing element 14 can, for example, have a closing head designed as a punch or attachment.

The electric drive device 18 is connected to the closing element 14 for driving the closing element 14 to move to and away from the container B. Preferably, the electric drive device 18 can move the closing element 14 vertically, for example in a vertical direction downwards towards the container B and in a vertical direction upwards away from the container B. Depending on the design of the closure 16, however, rotational movements of the closing element 14 driven by the electric drive device 18 are also possible.

Preferably, the electric drive device 18 can be connected to the closing element 14 via a capper drive axis 20, which is preferably movable only vertically, for moving the closing element 14. Preferably, the capper drive axis 20 is movable only vertically. The capper drive axis 20 can, for example, be elongated or rod-shaped. A longitudinal axis of the capper drive axis 20 is preferably aligned vertically. It is possible for the capper drive axis 20 to be coupled to a drive axis 22 of the electric drive device 18, for example detachably or integrally in one piece.

Preferably, the electric drive device 18 is an electric servo drive unit. For example, the servo drive unit is designed to follow a prespecified target movement, for example in the form of prespecified target positions for the capper drive axis 20 or drive axis 22. For this purpose, the servo drive unit can preferably detect actual positions, for example of the capper drive axis 20 or drive axis 22, and compare them with the prespecified target positions and regulate the further movement of the drive axis 22 depending on the comparison. A deviation between the actual position and the target position can be referred to as a following error.

Preferably, the electric drive device 18 is a linear drive device. The linear drive device can preferably move the closing element 14 only in a vertical direction downwards and upwards.

The apparatus 10 preferably has a plurality of stations, each with a container receptacle 12, a closing element 14 and an electric drive device 18, for the simultaneous or temporally overlapping closing of a plurality of containers B. The apparatus 10 can preferably be designed as a rotary device. For example, the stations can be arranged around a circumference of a carousel of the rotary device.

The user interface 24 can be designed to receive inputs from a user and/or to output information to a user. For example, user inputs can be haptic, acoustic, and/or gestural. For example, the information can be output to the user visually, acoustically, and/or haptically. The user interface 24 can, for example, have a preferably touch-sensitive display, a microphone, a loudspeaker, a signal light and/or at least one button or switch.

The processing device 26 is configured to operate the electric drive device 18 in order to move the closing element 14, as explained in detail below.

Preferably, the processing device 26 is part of a servo converter connected to the electric drive device 18. The servo converter can preferably have a cycle time in the three-digit μs range, particularly preferably ≤500 μs or ≤400 μs.

The further processing device 28 can, for example, be a processing device that is a higher-order processing device than the processing device 26. For example, the further processing device 28 can be a central processing device of the apparatus 10. The further processing device 28 can have a cycle time that is greater than a cycle time of the processing device 26. For example, the further processing device 28 can have a cycle time that is in the range between 3000 μs and 6000 μs, for example around 4800 μs.

It is possible for the processing device 26 and the further processing device 28 to be configured together to operate the electric drive device 18 in order to move the closing element 14. It is also possible for the processing device 26 to override the further processing device 28 in order to operate the electric drive device 18, for example to move or stop the closing element 14.

Preferably, the apparatus 10 is arranged downstream of a filling device, for example a rotary filling device, in relation to a container flow, for filling the containers B, for example with a liquid or pasty filling material. For example, the apparatus 10 can be a pure closing apparatus for closing the containers B.

However, it is alternatively possible for the apparatus 10 to be an integrated filling-closing apparatus, as shown by way of example in FIG. 1 by the dotted lines. The filling-closing apparatus can, for example, have a filling element 30 and optionally a treatment chamber 32.

The filling element 30 can be designed to fill the container B received in the container receptacle. The filling element 30 can fill the container B, for example, with a liquid or pasty filling material. For example, the filling element 30 can have a filling valve for selectively releasing or blocking the filling element 30. The filling element 30 can be connected to a filling material source (not shown), preferably a filling material tank. Preferably, the filling element 30 can also evacuate, pre-pressurize and/or flush the container B.

Preferably, the filling element 30 can be pressed against a container mouth of the container B in order to fill the container B. Preferably, an adjusting device can be assigned to the filling element 30. The adjusting device can move the filling element 30 in order to press it onto the container mouth and to release the container mouth. Preferably, the adjusting device can move an outlet of the filling element 30 within the treatment chamber 32. The adjustment device can move the outlet of the filling element 30 in order to press it onto the container mouth, for example when a treatment by the filling element 30 is desired, such as evacuating, flushing, pre-pressurizing and/or filling. The adjusting device can move the outlet of the filling element 30 away from the container mouth in order to make possible, for example, treatment of the container B by the closing element 14. The adjusting device can preferably move the filling element 30 along an axis which is inclined to a vertical axis of the station or the container B. The adjustment device can be driven for example electrically, electromagnetically, pneumatically, hydraulically or mechanically, for example controlled by the further processing device 28.

For the treatment by the filling element 30 and the closing element 14 at least an upper portion of the container B with its container mouth can be received in the treatment chamber 32. For example, the container B can be moved into the treatment chamber 32 by the container receptacle 12 in order to position the upper portion of the container B.

For the treatment, the portion of the container B received in the treatment chamber 32 can be received in a sealed manner in the treatment chamber 32. For example, the treatment chamber 32 can be sealed at the top by the closing element 14. For example, the treatment chamber 32 can be sealed at the underside to a container neck of the container B by means of a seal 34 (for example, a container neck seal). The seal 34 can, for example, take the form of an inflatable annular body that can be placed around a container neck of the container B.

It is possible for the treatment chamber 32 to be for example evacuated, flushed and/or pre-pressurized, preferably while the container B is pressed against the filling element 30.

An exemplary operation of the apparatus 10 is described below with reference to FIGS. 1 to 3.

The drive device 18 is operated in order to move the closing element 14 to the container B received in the container receptacle 12, for example by the further processing device 28 via the processing device 26. The movement of the closing element 14 to the container B preferably takes place in a vertical direction downwards. Normally, the closing element 14 first reaches an application position P1 (see FIG. 2) in order to start the application of the closure 16 to a container mouth of the container B. For example, the closure 16 can almost or already be in contact with a container mouth of the container B. After reaching the application position P1, the drive device 18 can be operated to move the closing element 14 from the application position P1 to a closing position P2 (see also FIG. 2) in order to finally apply the closure 16 to the container B.

However, it may happen that the closing element 14 is not able to reach its application position P1 or its closing position P2 due to premature contact with the container B, for example due to two closures 16 being fitted at the closing element 14 or due to a container B that is too high or a container B that is positioned too high in the container receptacle 12. Such situations should be detected and responded to by the method explained below.

When the drive device 18 is being operated to move the closing element 14 to the container B, a following error of the drive device 18 is monitored by the processing device 26, for example when moving the closing element 14 to the application position P1 and/or to the closing position P2 (see FIG. 2). The following error can preferably be monitored directly at the drive device 18, for example at its drive axis 22, or at the capper drive axis 20. During monitoring of following error, a deviation between a target position, preferably a target height position, for example of the drive axis 22, and an actual position, preferably an actual height position, for example of the drive axis 22, is preferably monitored.

When the monitored following error reaches or exceeds a prespecified limit value, the drive device 18 is operated to abort the movement of the closing element 14 to the container B and to move the closing element 14 away from the container B.

The limit value can preferably be a prespecified maximum deviation between the target position and the actual position. The limit value can be prespecified, for example, as ≤2 mm or ≤1.5 mm or ≤1 mm.

When the movement is aborted, the drive axis 22 can be braked. Preferably, the movement of the closing element 14 away from the container B can take place in a vertical direction upwards. In the away movement, the closing element 14 can be moved away to a specified target position which preferably corresponds to a starting position for the movement to the container B. Preferably, during the away movement the closing element 14 can move back along a movement path previously followed when moving to the container B.

While the operation of the drive device 18 for moving the closing element 14 to the application position P1 and/or to the closing position P2 preferably takes place by means of both processing devices 26, 28, the operation of the drive device 18 for aborting the movement of the closing element 14 to the container B and for moving the closing element 14 away from the container B preferably takes place only by means of the processing device 26, which overrides the further processing device 28.

Preferably, during the away movement from the container B, the drive axis 22 and thus the closing element 14 can move according to at least one parameter prespecified specifically for the away movement. Preferably, the parameter or parameters can be prespecified by means of the user interface 24. For example, a target position for the away movement, a speed for the away movement, an acceleration for the away movement and/or a deceleration for the away movement can be prespecified by means of the user interface 24.

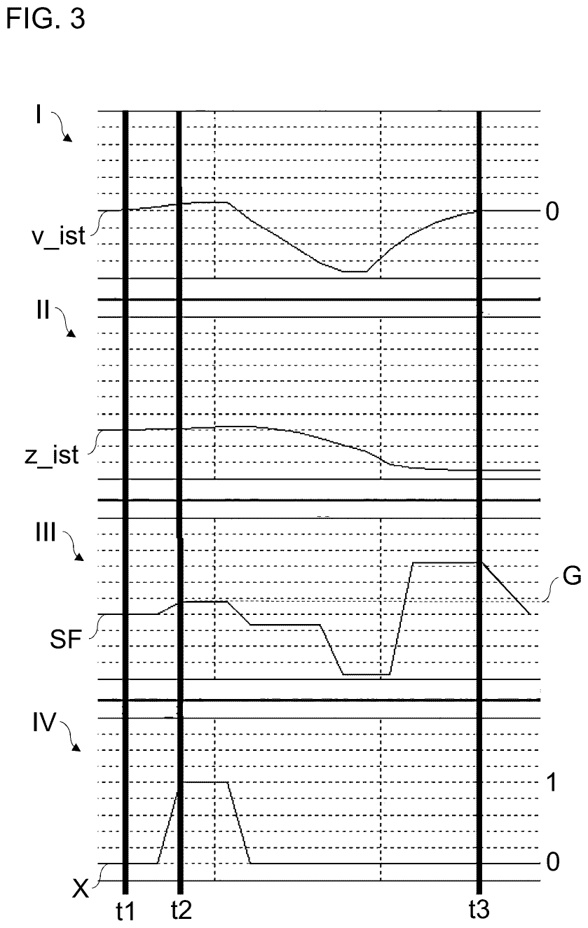

An example of monitoring is shown in FIG. 3. FIG. 3 shows four diagrams I, II, Ill and IV. Diagram I shows an actual speed v_actual of the drive axis 22 of the drive device 18 over time. Diagram Il shows an actual position z_actual of the drive axis 22 of the drive device over time. Diagram III shows an (actual) following error SF of the drive axis 22 over time. Diagram IV shows the state of a monitoring bit X over time. The monitoring bit X indicates whether the following error SF has reached/exceeded a limit value G (=1) or not (=0).

For example, the drive device 18 begins to move the closing element 14 to the container B at time t1. Accordingly, the drive axis 22 can be accelerated from time t1 (see diagram 1) and the actual position z_actual of the drive axis 22 changes starting from time t1 (see diagram 2). Initially, the following error SF can be comparatively small. At a time between 1 and t2, the closing element 14 with the closure 16 may, for the reasons explained above, contact the container B undesirably early, for example before the prespecified application position P1 (see FIG. 2). The container B can make further movement of the closing element 14 difficult and may hinder it, for example depending on the position of the container B in the container receptacle 12. The following error SF increases and can finally reach or exceed a prespecified limit value G at time t2 (see diagram 2). The monitoring bit X thus changes to 1 at time t2. As a result, the drive device 18 aborts the actually further intended movement of the closing element 14 to the container B, braking takes place, and finally movement takes place in an opposite direction, away from the container B. This can be seen in diagrams 1 and 2, wherein the negative sign of the actual speed v_actual indicates the opposite direction and the decreasing position value z_actual indicates a retraction of the drive axis 22. Before reaching a prespecified target point at time t3, the drive axis 22 is braked, whereby the current speed v_actual finally reaches 0 mm/s at time t3. The course of the following error SF after falling below the limit value G again is less relevant, since no (continued) monitoring of the following error SF takes place during the movement away from the container B.

It is possible for a visual or acoustic warning to be issued at the user interface 24 when the monitored following error reaches or exceeds the prespecified limit value G. For example, the processing device 26 may instruct the further processing device 28 to operate the user interface 24 to issue the warning.

It is also possible for the container B, which has not been closed or at least not completely closed, to be subsequently ejected. For example, information about this container B can be sent via the further processing device 28 to an ejection device arranged downstream of the apparatus 10, which ejection device can eject the relevant container B from the normal container flow.

It is also possible for the operation of the apparatus 10 to continue for closing subsequent containers without interruption despite the limit value G for the following error SF being exceeded.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the sub-claims are also disclosed independently of all the features of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 apparatus for closing containers
12 container receptacle
14 closing element
16 closure
18 electric drive device
20 capper drive axis
22 drive axis
24 user interface
26 processing device
28 further processing device
30 filling element
32 treatment chamber
34 seal
B container
G limit value
P1 application position
P2 closing position
SF following error
t1-t3 times
v_actual actual speed
X monitoring bit
z_actual actual position

1. A method for operating an apparatus for closing containers, the method comprising:
operating an electric drive device of the apparatus for moving a closing element of the apparatus to a container received in a container receptacle of the apparatus in order to apply a closure to the container;
monitoring a following error of the electric drive device during operation of the electric drive device in order to move the closing element to the container via a processing device of the apparatus; and
if the monitored following error reaches or exceeds a specified limit value, operating the electric drive device to abort the movement of the closing element to the container and to move the closing element away from the container.

2. The method according to claim 1, wherein at least one of the following conditions is met:
the movement of the closing element to the container takes place in a vertical direction downwards;
the movement of the closing element away from the container takes place in a vertical direction upwards;
during the away movement, the closing element is moved away to a specified target position; and
during the away movement, the closing element moves back along a movement path previously followed during movement to the container.

3. The method according to claim 1, wherein:
the monitoring of the following error of the electric drive device includes monitoring a deviation between a target position and an actual position.

4. The method according to claim 1, wherein:
the monitoring of the following error takes place at the electric drive device.

5. The method according to claim 1, wherein:
the movement comprises:
moving the closing element to an application position for starting an application of the closure to a container mouth of the container; and
moving the closing element from the application position to a closing position for applying the closure to the container mouth;
the monitoring of the following error takes place during operation of the electric drive device for moving the closing element to the application position, and/or
the monitoring of the following error takes place during operation of the electric drive device for moving the closing element from the application position to the closing position.

6. The method according to claim 1, wherein:
if the monitored following error reaches or exceeds the prespecified limit value:
a warning is issued at a user interface; and/or
the container assigned to the closing element during monitoring of the tracking error is subsequently ejected; and/or
an operation of the apparatus for closing subsequent containers is continued without interruption.

7. The method according to claim 1, wherein:
the processing device is part of a servo converter connected to the electric drive device.

8. The method according to claim 1, wherein at least one of:
the electric drive device is a servo drive unit;
during the away movement, the closing element is moved away to a specified target position that corresponds to a starting position of the movement to the container;
the monitoring of the following error of the electric drive device includes monitoring a deviation between a desired height position and an actual height position;
the monitoring of the following error takes place at one of a drive axis of the electric drive device, and at a capper drive axis which connects the electric drive device to the closing element;
the processing device is part of a servo converter connected to the electric drive device with a cycle time of at least 400 μs;
the prespecified limit value is a prespecified maximum deviation between the target position and the actual position; and
the prespecified limit value is at least 1 mm; and
the method further includes one of:
prespecifying, via a user interface of the apparatus, at least one parameter being at least one of a target position, a speed, an acceleration, and a deceleration, of the closing element, and
prespecifying, via a user interface of the apparatus, at least one parameter of the closing element for the away movement.

9. The method according to claim 1, wherein:
the operation of the electric drive device for moving the closing element to the container in order to apply the closure to the container is carried out via the processing device and a further processing device.

10. The method according to claim 9, wherein:
the operation of the electric drive device for aborting the movement of the closing element to the container and for moving the closing element away from the container is carried out via the processing device, which overrides the further processing device.

11. The method according to claim 9, wherein at least one of the following conditions is met:
the further processing device is a higher-level processing device than the processing device;
the further processing device has a longer cycle time than the processing device; and
the further processing device is a central processing device of the apparatus. 12 The method according to claim 1, further comprising:
prespecifying, via a user interface of the apparatus, at least one parameter of the closing element, specifically for the away movement,
wherein:
the operation of the electric drive device for moving the closing element away from the container takes place in accordance with the at least one specified parameter.

13. The method according to claim 1, wherein one of:
the apparatus is a pure closing apparatus; and
the apparatus is an integrated filling-closing apparatus.

14. The method according to claim 13, wherein at least one of:
the integrated filling-closing apparatus has a treatment chamber in which at least one container mouth of the container can be received in a sealed manner for the filling and closing of the container, and
the monitoring of the following error takes place only during the movement of the closing element within the treatment chamber.

15. An apparatus for closing containers, wherein the apparatus comprises:
a container receptacle for receiving a container;
a closing element which is movable for movement to a container received in the container receptacle in order to apply a closure to the container;
an electric drive device, wherein the electric drive device is connected to the closing element in order to drive the closing element to move to the container; and
a processing device configured to carry out a method according to claim 1.

16. The apparatus according to claim 15, wherein at least one of the following conditions is met:
the processing device is part of a servo converter connected to the electric drive device; and
the apparatus has a further processing device which, together with the processing device, is configured to operate the electric drive device to move the closing element to the container in order to apply the closure to the container.

17. The apparatus according to claim 15, further comprising:
a user interface configured to receive, by a user input, at least one parameter,
wherein:
the processing device is further configured to operate the electric drive device according to the at least one prespecified parameter for moving the closing element away from the container.

18. The apparatus according to claim 15, wherein at least one of:
the apparatus is a rotary closing apparatus;
the closing element is movable in a vertical direction downwards;
the electric drive device is a servo drive unit;
the electric drive device has a cycle time of at least 400 μs;
the processing device is configured to override the further processing device when
the processing device operates the electric drive device to abort the movement of the closing element to the container and to move the closing element away from the container;
the further processing device is a higher-level processing device than the processing device;
the further processing device has a longer cycle time than the processing device;
the further processing device is a central processing device of the apparatus; and
the apparatus further includes one of:
a user interface configured to receive, by a user input, at least one parameter being at least one of a target position, a speed, an acceleration, and a deceleration, of the closing element, and
a user interface configured to receive, by a user input, at least one parameter for the away movement.

19. The apparatus according to claim 15, wherein one of:
the apparatus is a pure closing apparatus; and
the apparatus is an integrated filling-closing apparatus.

20. The apparatus according to claim 19, wherein at least one of:
the integrated filling-closing apparatus has a treatment chamber in which at least one container mouth of the container can be received for the filling and closing of the container; and
the processing device is configured to monitor the following error during the movement of the closing element within the treatment chamber.
